(19) United States
(12) Patent Application Publication
(10) Pub. No.: US 2021/0060523 A1
(43) Pub. Date: Mar. 4, 2021

(54) MODIFIED PROTEIN ADSORBENTS FOR CONTAMINANT REMOVAL

(71) Applicant: The United States of America, as represented by the Secretary of Agriculture, Washington, DC (US)

(72) Inventors: Rafael A. Garcia, Dresher, PA (US); Matthew Essandoh, Philadelphia, PA (US)

(21) Appl. No.: 16/552,307

(22) Filed: Aug. 27, 2019

(51) Int. Cl. B01J 20/22; B01J 20/32; B01J 20/06; B01J 20/28; C02F 1/28

(52) U.S. Cl. CPC B01J 20/22; B01J 20/3274; C02F 2101/308; B01J 20/28016; C02F 1/286; B01J 20/06

(57) ABSTRACT

Disclosed are adsorbent compositions including a recoverable and reusable polypeptidylated hemoglobin iron composite and methods of using the compositions to adsorb and/or remove contaminant compounds from water involving contacting the water with an effective amount of the composition to remove the contaminant compounds.

### FIELD OF THE INVENTION

The disclosed invention relates generally to novel modified protein compositions and methods to remove contaminants and pollutants from wastewater and waterways. More specifically, the invention relates to recoverable and reusable polypeptidylated proteins capable of adsorbing a variety of inorganic and/or organic contaminants and pollutants.

### BACKGROUND OF THE INVENTION

Organic and inorganic contaminants from industrial processes and agricultural applications result in high levels of these contaminants in wastewater and waterways. A variety of industries including papermaking, paint, textiles, and leather manufacturing make extensive use of dyes (see e.g., Hashem et al., 2007). As a result of these and other manufacturing processes, a significant amount of dyes end up in wastewater streams, especially considering the amount of water used and the content of the discharge effluent. It has been reported that a significant amount of synthetic dyes (about 12%) used in the manufacturing and processing operations are lost, and roughly 20% of these lost dyes find their way into industrial wastewaters (see e.g., Weber et al., 1993; Clarke et al., 1980). Wastewater from industrial dye usage displays variations in characteristics such as biochemical oxygen demand (BOD), color intensity, and chemical oxygen demand (COD), and also reduces the aesthetic value of the water (see e.g., Ghoreishi & Haghighi, 2003). Concentration of dyes in effluents even at low levels significantly decrease the appearance of water and are highly undesirable (see e.g., Nigam et al., 2000). Organic dyes and particularly azo dyes are of primary concern due to their toxicity another issues. Among all the synthetic dyes used in various industries, azo dyes alone consist of approximately 70% of the global market (see e.g., de Luna et al., 2013). Furthermore, these azo dyes are the largest group of dyes, and are extremely difficult to degrade as result of their resistance to light, chemical, and microbial attack (see e.g., Gerçel et al., 2008). Pesticides are widely used chemicals in the agricultural industry that generally repel and/or cause mortality in target pests, such as insects, parasites, plant pathogens, microorganisms, etc. The most common use of pesticides is for plant and asset protection to increase agricultural productivity. Although pesticides have many benefits to the productivity and economics of agriculture, pesticide use raises a number of environmental concerns. For example, pesticides cause water, air, and soil pollution and contamination and also alter the natural balance of ecosystems. Furthermore, many pesticides are toxic to humans and are known to cause a variety of adverse health effects ranging from mile to severe. Collectively, these pollutants have a strong negative impact on water quality even at low concentrations and may also be carcinogenic and/or mutagenic.

Thus, efficient removal of contaminants and pollutants from wastewater and waterways is of primary importance. Industrial dyes in particular are very difficult to treat and remove due to their complex structure. Unfortunately, because of their high stability to temperature, detergents, and light, just to name a few, they elude most conventional treatment technologies. Wastewater treatment techniques such as membrane filtration, adsorption, oxidation, flocculation-coagulation, and biological treatment have been emphasized for the reprocessing of dye-contaminated wastewater (see e.g., Ahmad et al., 2015). Activated carbon, the standard industrial adsorbent, is very costly and requires an energy-intensive activation step for its production. Further, this conventional adsorbent is difficult to regenerate and reuse. It is therefore not surprising that various authors have synthesized alternative adsorbent materials for the removal of organic and inorganic contaminant from water/wastewater. Adsorption stands out as one of the best approaches for the removal of dye. Commercial activated carbon is the most common adsorbent used for dye removal; however, non-conventional and low-cost adsorbents are still being sought because of the high price of activated carbon. For example, there are reports of experimental adsorbent materials for the removal of Eriochrome black-T (EBT), a typical azo dye, from water including almond shell adsorbent and its modifications (see e.g., Şahin et al., 2013), NiFe₂O₄ nanoparticles (see e.g., Moeinpour et al., 2014), eucalyptus bark (see e.g., Dave et al., 2011), and rice hull-activated carbon (see e.g., de Luna et al., 2013). These materials are typically very high-priced, are hard to recover and recycle, and suffer from high activation and reactivation costs. Materials, such as biochar, clays, and other mineral-based materials have also been used, but typically these materials have a low adsorption capacity.

Magnetic substances have found a lot of applications including biosensing (see e.g., Diez et al., 2012), magnetic storage media (see e.g., Reiss & Hutten, 2005), and biomedical applications such as drug delivery and multi-imaging (see e.g., Lee et al., 2013). A nanohybrid of magnetite attached to exfoliated silica platelets has also been developed for attracting bacteria in microbiological media (see e.g., Liu et al., 2016). The magnetite attached to silicate platelets greatly helps in the capturing and destruction of the bacterial cells, and subsequently removing them using an external magnet. These broad applications of magnetic nanoparticles are mainly as a result of their non-toxicity, biodegradability, and ease of synthesis (see e.g., Wiogo et al., 2012). Compounds utilized in magnetic separation offer a unique advantage when it comes to the recovery of the spent separating agent because of the ease of separation. Despite advances in magnetic nanoparticles, not all sectors have come to appreciate the importance and other potential applications of magnetic substances. The disclosed inventive composition is highly practical because hemoglobin can easily be isolated from blood (a meat processing by-product) and incorporating the magnetic properties of an iron oxide in the syntheses of the disclosed adsorbent will enhance its recovery from aqueous wastewater.

There thus exists an urgent industrial need for improved compositions and methods to remove contaminants and pollutants from waste streams to protect waterways from industrial compounds that cause damage. There is a particular need for regeneratable and reusable adsorbent materials that are economical to recover and reuse.

### SUMMARY OF THE INVENTION

To address these challenging issues in the removal of contaminants and pollutants from wastewater and waterways, the present invention accordingly provides novel and highly efficient compositions and methods for removing such contaminants. The disclosed novel adsorbents have an interesting application for wastewater treatment and will further serve as a practical way to convert waste products generated in the agricultural industry into useful and effective adsorbents for the removal of organic and inorganic pollutants and contaminants.

In an aspect, the invention is a composition comprising an adsorbent having at least one type of protein, at least one type of peptide, and at least one type of iron oxide. In another aspect, the invention is a method of removing at least one type of contaminant from water where the water is contacted with an effective amount of the composition.

It is an advantage of the invention to provide applications of converting agricultural byproduct proteins into effective adsorbents for removal of contaminants and pollutants from wastewater and waterways.

It is a further advantage of the present invention to provide novel adsorbent compositions that utilize industrial waste products which may otherwise be discarded as effluent into the environment.

It is another advantage of the present invention to provide novel compositions and methods of using hemoglobin as a precursor for an adsorbent as a cost-effective way of diverting animal blood from disposal or other low-value usage.

It is yet another advantage of the present invention to provide compositions and methods characterized by recoverability and reusability magnetized polypeptidylated adsorbent proteins that are highly economical.

An additional advantage of the invention is to decrease sewage surcharges to blood processors.

This summary is provided to introduce a selection of concepts in a simplified form that are further described below in the detailed description. This summary is not intended to identify all key or essential features of the claimed subject matter, nor is it intended to limit the scope of the claimed subject matter.

### BRIEF DESCRIPTION OF THE DRAWINGS

FIG. 1A to 1D show FTIR spectra (1A), thermal gravimetric analysis (1B), zeta potential measurement (1C), and particle size distribution (1D) for the synthesized adsorbents.

FIG. 2 shows SEM images of (a, b) iron oxide, (c, d) 0.5:1 and (e, f) 1:1 adsorbent.

FIG. 3A to 3C shows nitrogen adsorption-desorption isotherms for iron oxide (3A), the 0.5:1 adsorbent (3B), and the 1:1 adsorbent (3C).

FIG. 4 illustrates the effect of adsorbent concentration on EBT removal using 40 mg of adsorbent, 20 mL of the EBT solution, and 2 h equilibration time.

FIG. 5A to 5B show the influence of solution pH for the adsorption of the EBT by the iron oxide and the synthesized adsorbents of the invention.

FIG. 6 shows proposed mechanisms (hydrogen bonding, electrostatic attraction, and charge-charge repulsion interaction) for the adsorption of EBT dye on 0.5 and 1:1 adsorbent.

FIG. 7 illustrates the capacity for the inventive compositions to be reused and regenerated over a number of cycles.

### DETAILED DESCRIPTION OF THE INVENTION

Unless herein defined otherwise, all technical and scientific terms used herein generally have the same meaning as commonly understood by one of ordinary skill in the art to which this invention belongs. The definitions and terminology herein described for embodiments may or may not be used in capitalized as well as singular or plural form herein and are intended to be used as a guide for one of ordinary skill in the art to make and use the invention and are not intended to limit the scope of the claimed invention. Mention of trade names or commercial products herein is solely for the purpose of providing specific information or examples and does not imply recommendation or endorsement of such products.

As used in the description of the invention and the appended claims, the singular forms “a,” “an,” and “the” are intended to include the plural forms as well, unless the context clearly indicates otherwise.

The term “consisting essentially of” excludes additional method steps or composition components that substantially interfere with the intended activity of the methods or compositions of the invention and can be readily determined by those skilled in the art (e.g., from a consideration of this specification or practice of the invention disclosed herein). This term may be substituted for inclusive terms such as “comprising” or “including” to more narrowly define any of the disclosed embodiments or combinations/sub-combinations thereof. Furthermore, the exclusive term “consisting” is also understood to be substitutable for these inclusive terms in alternative forms of the disclosed embodiments.

The term “contaminant” refers to any compound that results from an industrial process, wastewater treatment plants, sewage systems, chemical spills, agricultural runoff, etc. which is amenable to removal from wastewater or waterways using the inventive compositions or methods. Such compounds may include, for example, dyes or pesticides. Generally, the presence of an unwanted substance or the introduction of a chemical into the environment or the presence of a chemical that is not present naturally, is considered contamination. However, when there is a negative effect of this contamination on humans, plants or the environment, it is sometimes referred to as “pollution.” A contaminant though not desirable may or may not be harmful, however, pollutants are almost always harmful since they typically cause adverse effects.

The term “dye” refers to compounds that are used to impart color such as industrial dyes including eriochrome black T, indigo carmine, naphthol blue black, erythrosine, tartrazine, bromophenol blue, and the like. These compounds are typically soluble in water and/or organic solvents and azo-based compounds are the most common. These compounds are typically organic but may also less commonly be inorganic. Such compounds are commonly found in industrial dye applications in papermaking, paint, textiles, leather manufacturing, and as well as other industries.

The term “effective amount” of a compound or property as provided herein is meant such amount as is capable of performing the function of the compound or property for which an effective amount is expressed. As is pointed out herein, the exact amount required will vary from process to process, depending on recognized variables such as the compounds employed and various internal and external conditions observed as would be interpreted by one of ordinary skill in the art. Thus, it is may not be possible to specify an exact “effective amount,” though preferred ranges have been provided herein. An appropriate effective amount may be determined, however, by one of ordinary skill in the art using only routine experimentation.

The term “hemoglobin” or “Hb” refers to a protein found in red blood cells having a globular protein or globin with subunits linked to a heme molecule which collectively function in oxygen transport to tissues. For purposes of the present invention, hemoglobin is generally derived from waste blood products collected from animal slaughter facilities, including but not limited, for example, to mammalian (e.g., cattle, sheep, pig, etc.), avian (e.g., chicken, turkey, etc.), and fish sources.

The term “magnetic” refers to a substance that produces a magnetic field and is capable of being attracted to a magnet and/or showing a response to a magnetic field. For example, the iron oxide component of the polypeptidylated protein of the inventive composition is capable of magnetic attraction and when present imparts a magnetic characteristic to the polypeptidylated protein.

The term “optional” or “optionally” means that the subsequently described event or circumstance may or may not occur, and that the description includes instances and embodiments in which said event or circumstance occurs and instances and embodiments where it does not. For example, the phrase “optionally comprising one or more additional peptides” means that the composition may or may not contain one or more additional peptides and that this description includes compositions that contain and do not contain one or more additional peptides.

The term “peptide” or “polypeptide” refers to a relatively short chain (e.g., 2 or more) of alpha-amino acids linked through peptide bonds which can be produced synthetically or naturally-occurring. An exemplary method of using peptides for this invention is reacting N-carboxyanhydrides of alpha-amino acids with proteins. The new generated product of that reaction is referred to as a “polypeptidylated protein.” For example, primary amines on the surface of the protein starts the ring-opening polymerization of the N-carboxyanhydrides to produce polypeptide branches on the protein. The polypeptidylated protein MW increases since N-carboxyanhydrides incorporates one amino acid at a time. N-carboxyanhydrides that are used are actually reactive versions or derivatives of alpha-amino acids. Different amino acid reagents can be selected by a skilled artisan to control the properties of the polypeptides that are formed.

The term “protein” refers to any polypeptide encoded naturally or recombinantly in the genetic material of an organism. Examples include hemoglobin, enzymes, casein, albumin, etc.

The present invention provides a novel composition that is recoverable and reusable including a protein attached to a polypeptide and iron oxide for adsorbing contaminants from water such as industrial dyes, pesticides, and other chemicals used in the agricultural industry. In various embodiments as disclosed herein, the inventive composition functions as an efficient adsorbent for industrial dyes to reduce the negative environmental impact of such dyes. The composition may use a variety of protein sources as its base. A preferred protein is hemoglobin that is obtained from, for example, meat and poultry industry blood byproducts. Such animal blood is produced in slaughterhouses and represents a problematic byproduct due to the high volumes generated and its high pollutant load when discarded directly into the environment. The inventive composition includes an adsorbent having at least one type of protein, at least one type of peptide, and at least one type of iron oxide. The components are combined as discussed below. Not intending to be bound by theory, it is believed that the functional groups on the surface of the disclosed polypeptidylated adsorbent interact with various contaminants via electrostatic interaction and hydrogen bonding to surprisingly increase the adsorptive capacity and performance of the inventive composition.

The preferred protein component is hemoglobin, a globular protein, which is an inexpensive substance and has desirable adsorptive properties for organic and/or inorganic compounds (e.g., industrial dyes) when used as discussed herein. When hemoglobin (Hb) was used as the protein component in this invention, the composite produced was found to be a very strong adsorbent for the removal of both organic or inorganic contaminants from aqueous solutions. Not intending to be theory-bound, it is thought that the presence of both positive and negative charges on its surface cause hemoglobin to act as an effective adsorbent, and the attachment of peptides to create the inventive composition herein disclosed surprisingly increases its adsorptive capacity. The mechanisms of adsorption were rationalized through surface complexation-ligand exchange and hydrogen bonding. Annually, approximately 2 million tons of animal blood are produced in the US alone as a byproduct from slaughterhouses (see e.g., Del Hoya et al., 2007). Most of this blood is used in relatively low value animal feed applications or the blood commonly results in polluting the discharge water from the facility through the wastewater stream. However, hemoglobin can be a value-added waste product by easily being isolated from such blood to be used as a starting material or precursor for the preparation of the inventive composition herein disclosed thereby minimizing agricultural waste and converting it into useful products.

In embodiments, the protein component is modified (e.g., covalently modified) with one or more polypeptides to unexpectedly and surprisingly increase the adsorptive capacity of the protein. The polypeptide modification creates peptide protrusions or branches on the proteins and results in a polypeptidylated protein for use in the invention composition. The resulting polypeptidylated protein has additional functional groups (e.g., carbonyl, carboxyl, amino etc.) which provides desired adsorbent functionality. It is envisioned that this novel protein/peptide composite can be tailored to target particular organic and/or inorganic contaminants as needed to support different application areas. The peptide component to form the inventive composition is selected from reactive forms of amino acids such as amino acid N-carboxyanhydrides (sometimes referred to as “NCA”). NCAs typically react with protein through ring-opening polymerization (NCA-ROP) reaction. Nucleophiles on the surface of Hb can initiate the ring-opening polymerization of an amino acid N-carboxyanhydride to yield a polypeptidylated protein with homopolypeptide branches. Typically, homopolypeptide branching is produced if one type of NCA is used for the reaction. Heteropeptide branching could also be produced if a different NCAs were used simultaneously or successively. It should be appreciated that a skilled artisan could select desired NCAs to produce an optimized polypeptidylated protein for a particular application.

The polypeptidylated protein can subsequently bind to iron oxide during, for example, chemical co-precipitation to yield a magnetic product as discussed below. The derivative of the peptide used in the reaction is, for example, boc-trp-N-carboxyanhydride. Nonetheless, the side chains like boc and trp can be replaced by different compounds (e.g. serine-N-carboxyanhydride, valine-N-carboxyanhydride, or boc-gly-N-carboxyanhydride). Such compounds will react as desired with hemoglobin to produce a polypeptidylated protein. Nonetheless, it is not desirable to use extremely bulky N-carboxyanhydrides as this might slow the reaction due to steric hindrance. It should be appreciated that a skilled artisan would select the desired amino acid-N-carboxyanhydride(s) for a particular application to best fit the mix of contaminants to be adsorbed. Further, the product generated is generally larger in terms of molecular weight compared to the native protein. When NCAs are used, because of the ring opening polymerization, the product generated will have a larger molecular weight compared to the native protein.

In embodiments, the inventive composition comprises a magnetic component. The polypeptidylated protein is mixed with at least one type of iron oxide in an amount effective to generate a metallic composite substance. The method of forming the magnetized polypeptidylated protein requires that the protein first be polypeptidylated followed by the addition of a magnetic component. For example, a polypeptidylated hemoglobin/Fe₃O₄ composite may generally be prepared by a process involving adding the polypeptidylated hemoglobin to an aqueous solution containing Fe³⁺ and Fe²⁺ salts (e.g., ferric sulfate and ferrous sulfate in an about 2:1 molar ratio) and then adding a base (e.g., NaOH, KOH, Ca(OH)₂, etc.) to the aqueous solution until the pH of the aqueous solution is about 10 (e.g., pH about 9 to about 12) to form the polypeptidylated hemoglobin/iron oxide composite, and recovering (e.g., using a magnet to ensure recovered composite is magnetic; or after the reaction, polypeptidylated hemoglobin/iron oxide composite settles to the bottom of the solution and the supernatant is decanted followed by washing the composite several times with water to reduce the pH to ˜7) the polypeptidylated hemoglobin/iron composite from the aqueous solution. In this example, the Fe₃O₄ is not formed separately before adding it to polypeptidylated Hb, instead polypeptidylated Hb is mixed with Fe³⁺ and Fe²⁺ salts solution before adding base to the mixture. Thus, as the magnetic polypeptidylated Hb particles are being generated in solution, the polypeptidylated Hb is already in solution. The process is generally conducted at room temperature and does not require temperatures above about 40° C. In general, it is preferred to keep the temperature between about 25° and about 40° C. In some cases, it is possible to increase the temperature up to about 80° C. The size of the inventive composite after being magnetized is from about 10 nm to about 12 nm.

The magnetic component enables the inventive composition to have the additional benefit of magnetic attraction for ease of recovery and ability to be reactivated for multiple reuse cycles. Besides adding the ability to easily recover the inventive particles, the iron oxide component makes the whole composite insoluble in solution, which is typical for an adsorbent. Without iron oxide the polypeptidylated protein would be soluble in solution and would not be useful for removing the contaminants as desired. Magnetic particles (e.g., particles which show response to magnetic field gradients) exist in different sizes and shapes. Among the various magnetic particles, iron oxide particles (e.g., magnetite (Fe₃O₄), maghemite (γ-Fe₂O₃), etc.) have been found to be most effective in the inventive composition. The iron oxide component of the inventive composition is selected generally from salts of Fe³⁺ and Fe²⁺ (e.g., ferric sulfate (iron III) and ferrous sulfate (iron II) in from about 1.5:1 to about 2.5:1, or about 1.5:1, or about 2:1, or about 2.5:1 molar ratio) which attach to the polypeptidylated protein through a multifactorial process such as hydrogen bonding and Van der Waals interactions (see e.g., Saptarshi et al., 2013). It should be appreciated that the particular ratio and type of magnetic particle used is determined and adjusted by a skilled artisan to create the inventive composition with the desired size and adsorptive characteristics. When combined with an iron oxide particle, the inventive composition gains magnetic properties which are useful for removing/recovering spent adsorbent from water, and also for regenerating/recycling the adsorbent.

In addition, the disclosed composition does not require an activation step (e.g., physical or chemical activation) as is generally used in the production of activated carbon, a well-known and conventional industrial standard for wastewater purification. An activation step is typically used to create space or remove less organized loosely bound materials in the precursor. This process increases the surface area and pore volume of the precursor by heating it to high temperature such as 800° C. to 1000° C. in the case physical activation or 200° C. to 800° C. in the case of chemical activation. The lack of a required activation step substantially reduces the steps required for the production of the inventive composite as compared to conventional adsorbents and also reduces the amount of chemicals and reagents needed to produce the composite.

In embodiments, the concentrations of the components in the inventive composition to encompass various embodiments as described herein are as follows in terms of the ratio of concentration (in mg/L) of protein(s) to that of peptide(s) used to prepare the inventive adsorbent is from about 20:1 to about 2:1, or from about 15:1 to about 3:1, or from about 10:1 to about 4:1, or from about 7:1 to about 5:1 for an exemplary 0.5:1 adsorbent and from about 5:1 to about 45:1, or from about 10:1 to about 40:1, or from about 15:1 to about 35:1, or from about 20:1 to about 30:1 for an exemplary 1:1 adsorbent. In embodiments, the mass ratio of protein to iron oxide is from about 0.0625:1 to about 2:1, or from about 0.125:1 to about 1.5:1, or from about 0.25:1 to about 1:1, or from about 0.375:1 to about 0.75:1 for an exemplary 0.5:1 adsorbent or from about 0.125:1 to about 3:1, or from about 0.25:1 to about 2.5:1, or from about 0.5:1 to about 2:1, or from about 0.75:1 to about 1.5:1 for an exemplary 1:1 adsorbent. The referred exemplary 0.5:1 and 1:1 adsorbents are illustrated in Example 1.

In embodiments, the form of the inventive composition is generally a substantially pure composition in solid form, or, in other embodiments as a powder, liquid, semi-solid, powder, granule, tablet, gel, and combinations thereof. In solid form, the composition would be added to a volume of water in an effective amount depending on the level of contaminants in the water. In embodiments, the form of the invention may also be a suspension of the inventive composition an any concentration determined by a skilled artisan for use under a particular set of conditions.

The novel polypeptidylated adsorbent herein disclosed is useful for adsorbing a variety of inorganic and/or organic compounds (e.g., contaminants) found in industrial and agricultural settings. Organic compounds may include, for example, dyes such as azo (e.g., tartrazine, eriochrome black T, etc.), diazo (e.g., naphthol blue black), arylmethane (e.g., bromophenol blue), xanthene (e.g., erythrosine or erythrosin B), and indole dyes (e.g., indigo carmine). Other organic compounds include, for example, pesticides like organophosphorus, triazine, atrazine, glyphosate, 2,4-dichlorophenoyxacetic acid, naphthalene, pentachlorophenol, chloropyrifos, catechol, trichloroethylene, and organochlorine compounds used in the agricultural sector. Inorganic compounds may include, for example, zinc, chromium, copper, heavy metals such as lead or cadmium, and agricultural contaminants such as arsenic.

The percentage of contaminants the inventive composition can remove from water depends on the dose of adsorbent used. For example, with the contaminant substances tested in the below examples, more than 95% of the contaminants (e.g., about 100 mg/L to about 200 mg/L) can typically be removed from aqueous solution with just an adsorbent dose from about 2 g/L to about 4 g/L. Lower doses of adsorbent may also be used (e.g., less than about 2 g/L or about 1 g/L) to achieve contaminant removal less than 95%. Generally, about 0.003 to about 0.06 g adsorbent is used per mg contaminant in the water, or about 0.015 to about 0.04 g/mg, or about 0.075 to about 0.02 g/mg (e.g., 0.075 g/mg to 0.02 g/mg). In another example, polypeptidylated Hb and iron oxide may be prepared in a mass ratio from about 0.5:1 to about 1:1 and applied in an effective amount to achieve an adsorption capacity of greater than about 200 mg contaminant per gram of adsorbent.

The disclosed adsorbents were thermally and chemically stable under the adsorption the tested experimental conditions as discussed in the below examples. Evidence for the reuse of the inventive adsorbents was also affirmed with their adsorption capacities reducing to about 33 mg/g after their fourth cycle from their initial capacities of −49 mg/g. In embodiments, the initial adsorption capacity ranges up to about 200 mg/g. Chemical regeneration was successfully carried out using, for example, methanol and the reusability of the adsorbents were demonstrated in the examples below. After regeneration, the adsorption capacity tends to decrease gradually. Not intending to be bound by theory, this decrease might be because not all the contaminants are totally washed off (e.g., strongly bound to the adsorbent) or the surface of the adsorbent will gradually be destroyed after successive regeneration.

Other compounds may be added to the method or composite provided they do not substantially interfere with the intended activity and efficacy of the disclosed methods or compositions. Whether or not a compound interferes with activity and/or efficacy can be determined, for example, by the procedures utilized in the below examples.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurement. The following examples are intended only to further illustrate the invention and are not intended in any way to limit the scope of the invention as defined by the claims.

### Example 1

This example illustrates an embodiment for the synthesis of a polypeptidylated hemoglobin of the invention. Dimethyl sulfoxide (assay >99.5%), bovine hemoglobin (lyophilized powder, H2625), boc-trp-N-carboxyanhydride (NCA) (assay >98, iron (II) sulfate heptahydrate, and iron (III) sulfate hydrate were all purchased from MilliporeSigma (St. Louis, Mo.) and used without further purification. NCA solution (80 mg/mL) was prepared in dimethylsulfoxide. Two different Hb concentrations, 15 and 60 mg/mL, were prepared in aqueous solution. NCA stock solution was added such that the final NCA concentration in each sample was 2.5 mg/mL. The samples were stirred at a speed of 200 rpm for 24 h using a magnetic stirrer at 4° C. to produce the inventive polypeptidylated hemoglobin at the indicated concentrations.

A polypeptidylated Hb-supported iron oxide composite (i.e., a magnetic version of the polypeptidylated hemoglobin (Polypeptidylated Hb@Fe₃O₄)) was also synthesized. Chemical co-precipitation method using iron (III) and (II) in a molar ratio of 2:1, in an inert atmosphere, was used to add the magnetic component to the polypeptidylated Hb. The samples were prepared such that the ratio (in terms of mass) between the polypeptidylated Hb and iron oxide were 0.5:1 and 1:1, subsequently called 0.5:1 and 1:1 adsorbent, respectively. The reactions were then stirred gently for about 3 h before being allowed to settle for about a week. The samples were washed three times with water through centrifugation (5 k×g, 10 min, 22° C.) until the pH was near neutral. The adsorbents were lyophilized and stored in a desiccator until needed. A sample containing only iron oxide (Fe₃O₄) was also prepared for comparison purposes.

### Example 2

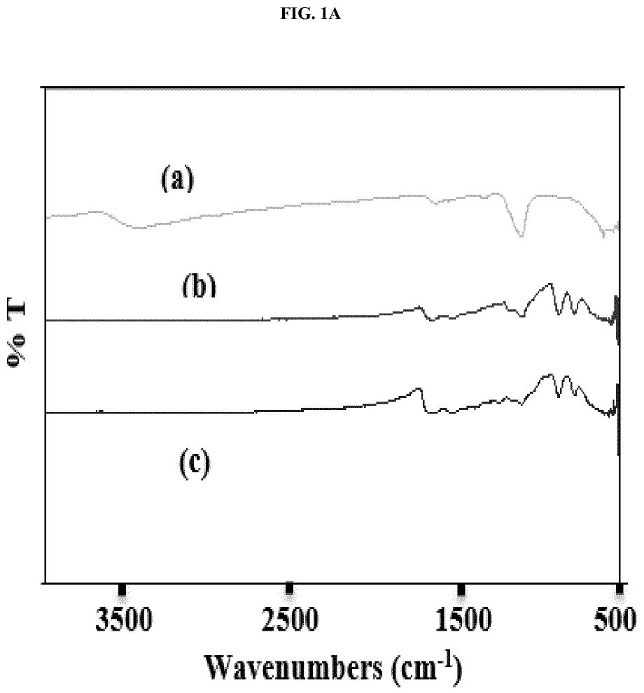

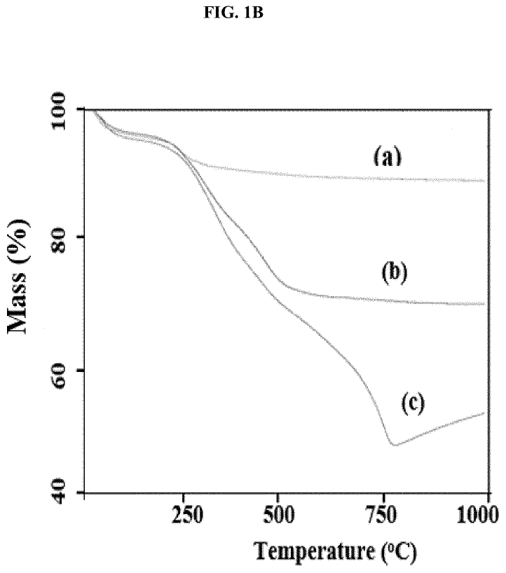

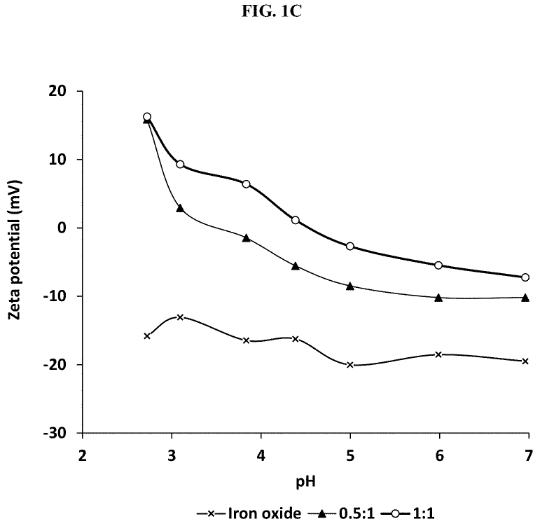

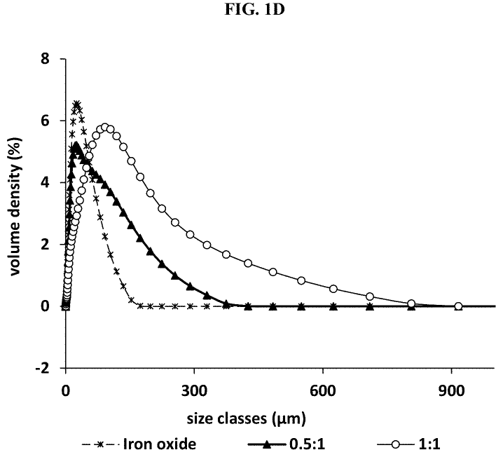

This example illustrates certain measurements and characteristics of the adsorbents produced in Example 1. These measurements provide important information about the inventive composite including the functional groups on the composite that interact with the contaminants, temperature resistance of the composite, and size distribution. FIG. 1A to 1D show FTIR spectra (1A), thermal gravimetric analysis (1B), zeta potential measurement (1C), and particle size distribution (1D) for the synthesized adsorbents. Labels (a), (b) and (c) in FIGS. 1A and 1B represent iron oxide, 0.5:1 and 1:1 inventive adsorbent, respectively. The infrared spectra of the adsorbent were measured using a Thermo Nicolet 6700 FT-IR (Thermo Electron Corporation, Madison, Wis.) spectrometer while the weight change in the material as a function of increasing temperature was studied using a TA Instruments Q500 thermal analyzer (TA Instruments, Delaware, USA). For zeta potential measurement, samples dissolved in citrate-phosphate buffer (pH 2.7-7.0) were measured using Zetasizer Nano Z (Malvern Instrument Inc., Westborough, Mass.). Particle size distribution was determined using a laser diffraction particle size analyzer (Mastersizer 3000, Malvern Instruments, Worcestershire, UK). TriStar II Plus (Micromeritics, Norcross, Ga.) was used for N₂-adsorption/desorption isotherm. Brunauer-Emmett-Teller (BET) method was used for surface area calculation. Scanning electron microscope, FEI Quanta 200 F (Hillsboro, Oreg., USA) was used to obtain high-resolution imaging of the samples.

All tested adsorbents (iron oxide, 0.5:1 and 1:1) exhibited bands at 570 cm⁻¹ corresponding to Fe—O vibration. The band around 3400 cm⁻¹ shows the presence of surface hydroxyl group on the iron oxide. Also, bands at 796 and 889 cm⁻¹ (═C—H bending) including 1690 cm⁻¹ (C═O stretch) were observed in the 0.5:1 and 1:1 adsorbent. The change in mass with respect to temperature is depicted in FIG. 1B. Weight loss in the adsorbent from 25° C. to 200° C. is about 5%. This weight loss was likely due to the loss of adsorbed water molecules and/or surface hydroxyl groups (see e.g., Yu & Chow, 2004). Thus, these adsorbents will be thermally stable under normal wastewater treatment temperature conditions. The rate of mass loss increases in the order: iron oxide <0.5:1<1:1. At 1,000° C., the weight of adsorbents remaining were 90%, 70%, and 50% for iron oxide, 0.5:1 and 1:1 adsorbent, respectively. This result is an indication that the thermal decomposition was directly influenced by the presence of Hb molecules used in the polypeptidylation reaction.

FIG. 1C shows the zeta potential measurement as a function of solution pH (using citrate-phosphate buffer). The zeta potential values provide information with respect to which pH levels of wastewater will cause the inventive material to be neutral, positively charged, or negatively charged. One skilled in the art would utilize this knowledge to determine the particular form of composite to use for different wastewater conditions to optimize adsorption capacity for those conditions. The pH_{zpc} of the 0.5:1 and 1:1 adsorbent, which is the pH at which the adsorbent exhibits zero net electrical charge was 3.9 and 4.6, respectively. The point of zero charge (pH_{zpc}) of iron oxide was not found as it was still negative during the entire measurement. However, when the citrate-phosphate buffer was changed to 10 mM KCl, the pH_{zpc} of iron oxide was about 7.7. The pH_{zpc} of iron oxide is known to be influenced by several parameters with ions and temperature being the dominant factors (see e.g., Cornell & Schwertmann, 2003).

Laser diffraction particle size analyzer data (FIG. 1D) shows a wide size distribution range from 1-1000 μm for all the synthesized adsorbents. The de Brouckere means were 30.7, 53.8, and 107 μm while Sauter mean was 12, 16.1, and 25.5 μm for iron oxide, 0.5:1 and 1:1, respectively. Detailed information about the adsorbents including the distribution width (D10, D50, and D90) can be found in Table 1.

TABLE 1

| | Iron oxide | 0.5:1 | 1:1 |
|---|---|---|---|
| Sauter mean (μm) | 12 | 16.1 | 25.5 |
| de Brouckere mean (μm) | 30.7 | 53.8 | 107 |
| D10, μm | 5.6 | 7.7 | 11.4 |
| D50, μm | 22.9 | 31.7 | 70.4 |
| D90, μm | 67.5 | 133 | 251 |
| Span | 2.71 | 3.95 | 3.41 |

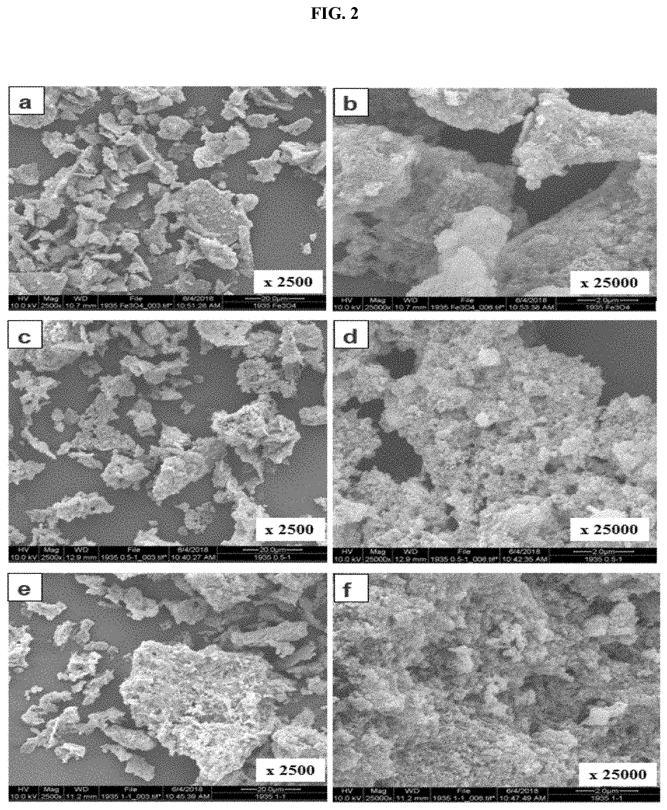

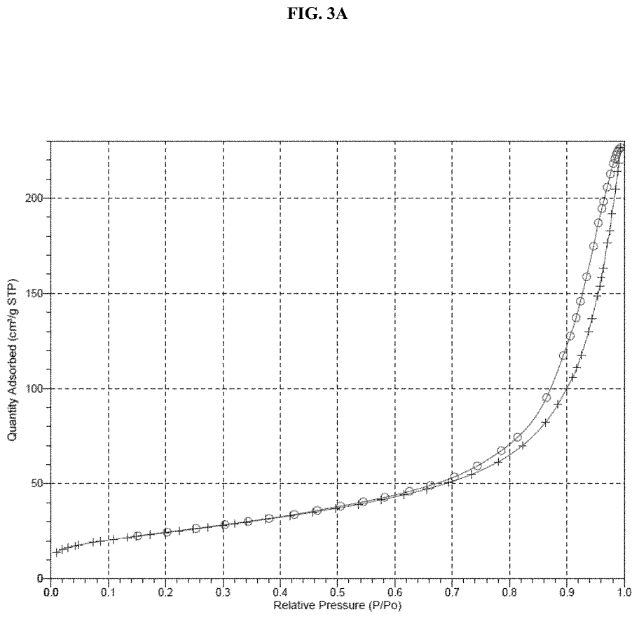

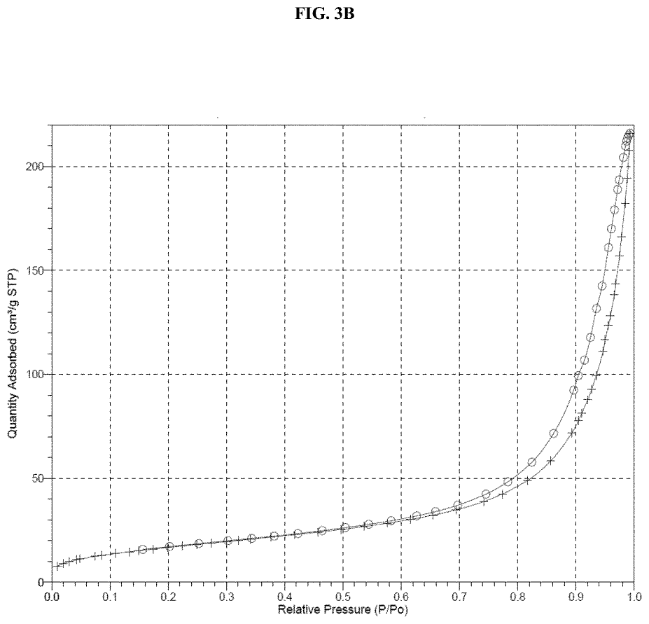

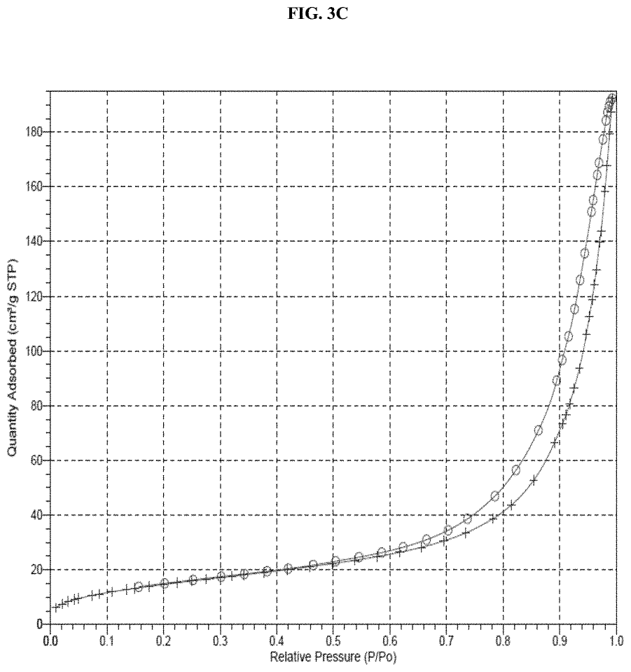

Scanning electron microscopic (SEM) images of the synthesized adsorbents are shown in FIG. 2. The SEM was used to study the surface topography and composition of the synthesized adsorbents. It is clear from these images that the Hb molecules are incorporated on/into the surface of the iron oxide. The iron weight percent analyzed by SEM-EDX decreases with increasing amount of Hb used in synthesis of the adsorbent; specifically, iron weight percent was found to be 67.7%, 52.3%, and 9.3%, for iron oxide, 0.5:1, and 1:1 adsorbent, respectively. The N₂ adsorption-desorption isotherm, which shows an unrestricted monolayer-multilayer adsorption (type II adsorption) is shown in FIG. 3A to 3C (where FIG. 3A shows iron oxide, FIG. 3B shows the 0.5:1 adsorbent, and FIG. 3C shows the 1:1 adsorbent) and the parameters obtained are shown in Table 2. This data is used by a skilled artisan to predict the maximum adsorption capacity of the inventive composite for a particular application. The surface areas were found to be 87.26, 61.70, and 54.33 m²/g for iron oxide, 0.5:1 and 1:1 adsorbent, respectively. The reduction in surface area is presumably due to the blockage of the pores of iron oxide by the Hb used in the synthesis reaction.

TABLE 2

| | Fe₃O₄ | 0.5:1 | 1:1 |
|---|---|---|---|
| BET surface area, m²/g | 87.26 | 61.70 | 54.33 |
| BJH adsorption cumulative surface | 107.35 | 81.19 | 73.45 |
| area of pores, m²/g | | | |
| BJH desorption cumulative surface | 111.07 | 82.01 | 75.82 |
| area of pores, m²/g | | | |
| Single point adsorption total pore volume | 0.35 | 0.33 | 0.30 |
| of pores, cm³/g | | | |
| Single point desorption total pore volume | 0.35 | 0.33 | 0.30 |
| of pores, cm³/g | | | |
| BJH adsorption cumulative volume of | 0.37 | 0.35 | 0.31 |
| pores, cm³/g | | | |
| BJH desorption cumulative volume of | 0.37 | 0.35 | 0.31 |
| pores, cm³/g | | | |
| Adsorption average pore diameter, A | 160.66 | 216.72 | 218.99 |
| Desorption average pore diameter, A | 159.97 | 215.72 | 217.79 |
| BJH adsorption average pore width, A | 136.17 | 171.81 | 169.67 |
| BJH desorption average pore width, A | 132.47 | 170.45 | 165.16 |

### Example 3

This example illustrates the stability of the adsorbent synthesized according to Example 1. To assess stability, 40 mg of the adsorbent was suspended in 20 mL of 2 different solvents (water and 0.01 M HCl) and rotated at room temperature for 2 h. The concentration of iron and hemoglobin that leached into the aqueous solution were studied using the “Iron, Phananthroline TNTplus Method” (Hach, Loveland, Colo.) and the alkaline heamatin D-575 method (see e.g., Zander et al., 1984), respectively. The adsorbents were tested for their tendency to leach into solution during the dye adsorption process. The concentration of Hb was found to be small (0.31 mg/mL). The concentration of iron under the adsorption experiment conditions (using water) all showed values less than 0.2 mg/L (see Table 3), which is an indication that the amount of iron leached into solution is less than the secondary maximum contaminant level for iron (0.3 mg/L). However, under acidic conditions (using 0.01 M HCl), concentrations of iron leached into solution were between 9.74-12.5 mg/L. This amount of leachate is not uncommon as previous research shown that under highly acidic conditions iron nanoparticles have potential to leach into solution (see e.g., Wang et al., 2010).

TABLE 3

| | Iron oxide, | 0.5:1, | 1:1, |
|---|---|---|---|
| | Fe (ppm) | Fe (ppm) | Fe (ppm) |
| Water | 0.118 | 0.183 | 0.041 |
| 0.01 M HCl | 12.5 | 9.74 | 11.5 |

### Example 4

This example demonstrates the ability of the adsorbent prepared in Example 1 to adsorb the dye Eriochrome black-T (EBT). EBT was obtained from MilliporeSigma (St. Louis, Mo.), and used without further purification. EBT is an azo dye with the formula C₂₀H₁₂N₃NaO₇S and molecular weight of 461.38 g/mol. The natural pH of an aqueous EBT dye solution is 5.82 and its structure for illustration purposes is shown in Structure 1. For a typical experiment, 60 mg of the adsorbent was suspended in 30 mL of 50 mg/mL of the EBT dye and rotated at room temperature for 2 h until equilibrium was reached (typically about 2 h).

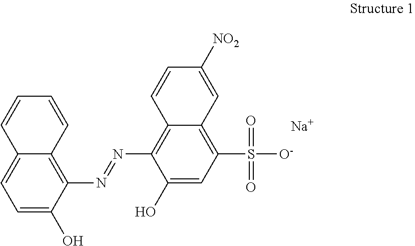 [SMILES: O=[N+]([O-])c1ccc2c(/N=N/c3c(O)ccc4ccccc34)c(O)cc(S(=O)(=O)[O-])c2c1 ; [Na+]]

### Example 5

This example illustrates adsorption kinetic data related to the dye adsorption capacity of the inventive composition. For isotherm studies, different concentrations (10-700 mg/mL) of the EBT dye were used with 40 mg of the adsorbent and 20 mL of the dye solution. For pH studies, 40 mg of the adsorbent with 20 mL of 150 mg/mL dye from pH 4-9 were studied using 25 mM MMT buffer (see e.g., Garcia et al., 2013). The adsorption capacity was calculated using Equation 1:

$${q}_{e} = \frac{( {C}_{o} - {C}_{e} ) V}{m} \qquad Equation 1$$

where Cₒ and Cₑ are the initial and equilibrium dye concentrations (mg/L) in solution, V is the volume (L) of the dye solution, m is the mass of adsorbent (g), and qₑ is the amount of dye (mg) removed per gram of adsorbent. All experiments were carried out in duplicate and the average results are presented unless otherwise stated.

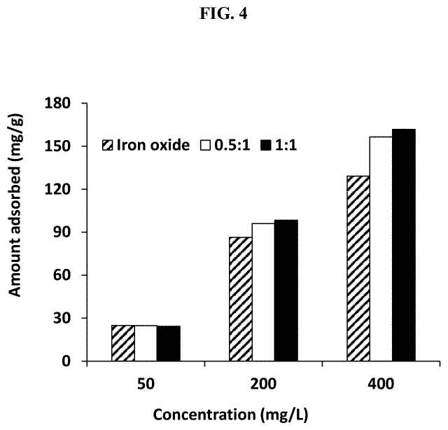

To gain insight into the adsorption kinetics, the pseudo-first and second order models were explored. The linear form of pseudo-first and second order equation was calculated using Equations 2 and 3, respectively:

$$\begin{matrix}log ( {q}_{e} - {q}_{t} ) = log {q}_{e} - \frac{{k}_{1} t}{2.303} & Equation 2 \\ \frac{t}{{q}_{t}} = \frac{1}{{k}_{2} {q}_{e}^{2}} + \frac{t}{{q}_{e}} & Equation 3\end{matrix}$$

where, qₑ and qₜ are the amount of dye adsorbed at equilibrium and at time “t,” respectively, and k₁ and k₂ are the first and second order rate constants, respectively. Table 4 conveys information on the calculated and experimental qₑ values obtained when the experimental data are fitted to Equations 2 and 3. The difference between the experimental and calculated qₑ values are large in the case of pseudo-first order kinetics (R² between x-y), implying that the data may not be suited for this order of reaction. However, pseudo-second order kinetic model (R² between x-y) likely represent the removal of EBT onto the studied adsorbents considering the fact the difference in the calculated and experimental qₑ values were small. It was also observed that the amount of dye adsorbed increases with increasing concentration of adsorbent (FIG. 4). Thus, there are more available sites on the surface of the adsorbent for adsorption to occur even at high EBT concentrations. The amount removed (˜24 mg/g or −95%) was similar for the different adsorbents at lower concentration (50 mg/L). However, at higher concentration (e.g., 400 mg/L) the amount adsorbed increases slightly in the order iron oxide <0.5:1<1:1. Table 4 shows that at an initial dye concentration of 150 mg/L, the experimental amount of dye adsorbed was found to be 66.4, 74.5, and 94.1 mg/g for iron oxide, 0.5:1 adsorbent, and 1:1 adsorbent, respectively. These values (amount adsorbed) were surprisingly and significantly higher for the inventive composite than the iron oxide, which is an indication that the inventive composite is superior in terms of its ability to adsorb dyes. It was surprising and unexpected to discover the inventive composition had such enhanced performance over the control iron oxide. As mentioned previously, the experiments were done in duplicates and average results are presented.

TABLE 4

| | Initial | | | | |
|---|---|---|---|---|---|
| | conc. | qₑ, exp. | qₑ, calc. | k₂ | |
| Adsorbent | (mg/L) | (mg/g) | (mg/g) | (gmg⁻¹h⁻¹) | R² |
| Iron oxide | | | | | |
| | 150 | 66.4 | 66.2 | 0.38 | 0.999 |
| | 300 | 105.1 | 106.4 | 0.02 | 0.997 |
| 0.5:1 | | | | | |
| | 150 | 74.5 | 74.6 | 1.79 | 1.000 |
| | 300 | 142.0 | 142.9 | 0.04 | 0.999 |
| 1:1 | | | | | |
| | 150 | 94.1 | 96.2 | 0.02 | 0.999 |
| | 300 | 139.3 | 138.9 | 0.09 | 1.000 |

### Example 6

This example illustrates adsorption isotherm data related to the dye adsorption capacity of the inventive composition. Table 5 shows the results obtained after computing the experimental data using Freundlich and Langmuir isotherms. The Freundlich isotherm model (see e.g., Freundlich, 1906), which takes into account the heterogeneity of adsorption sites was computed using Equation 4:

$$log {q}_{e} = log {k}_{f} + \frac{1}{n} log {C}_{e} \qquad Equation 4$$

where k_{f} and 1/n represent the Freundlich adsorptive capacity and surface heterogeneity, respectively. The surface heterogeneity, which encompasses from 0 to 1, becomes less heterogeneous as it approaches 1 (see e.g., Haghseresht & Lu, 1998). The adsorption process is found to be poor, moderately difficult, favorable, and approaching non-reversible isotherm when n<1, 1<n<2, 2<n<10 and n >10, respectively (see e.g., Elsherbiny et al., 2018). The calculated values of n as shown in Table 5 were between 2<n<10, indicating favorable adsorption under current experimental conditions.

TABLE 5

| | | Fe₃O₄ | 0.5:1 | 1:1 |
|---|---|---|---|---|
| Langmuir | Q° (mg/g) | 123 | 204 | 217 |
| | b | 0.15 | 0.08 | 0.07 |
| | R² | 0.972 | 0.972 | 0.982 |
| Freundlich | k_{f} (mg/g) | 22 | 48 | 43 |
| | 1/n | 0.37 | 0.27 | 0.30 |
| | n | 2.7 | 3.7 | 3.3 |
| | R² | 0.756 | 0.947 | 0.834 |
| Weber and | R_{L} | 0.0094 to | 0.017 to | 0.02 to |
| Chakravorti | | 0.40 | 0.55 | 0.59 |

The Langmuir isotherm was estimated using Equation 5:

$$\frac{C e}{{q}_{e}} = \frac{C e}{{Q}^{0}} + \frac{1}{b {Q}^{0}} \qquad Equation 5$$

where b is the Langmuir isotherm constant (L/mg) and Q⁰ is the monolayer adsorption capacity (mg/g), assuming a homogenous adsorption and also no interaction between adsorbed molecules. The Langmuir monolayer adsorption capacities were found to be 123, 204, and 217 mg/g for Fe₃O₄, 0.5:1, and 1:1 samples, respectively. This increase in adsorption capacity of the modified samples (0.5:1 and 1:1 adsorbents) compared to the control (Fe₃O₄) might be related to the increase in pore diameter and pore width of the modified samples (see Table 2).

Further insight about the nature of adsorption can be derived from b, the Langmuir constant, using Weber and Chakravorti (1974) Equation 6:

$${R}_{L} = \frac{1}{1 + b {C}_{o}} \qquad Equation 6$$

where R_{L} is the separation factor, a dimensionless constant. A R_{L}>1, R_{L}=1, 0<R_{L}<1 and R_{L}=0 depict unfavorable, linear, favorable, and irreversible adsorption, respectively. It is shown in Table 5 that the adsorption of EBT dye onto all the studied adsorbents were favorable as their R_{L} values were between 0 and 1.

### Example 7

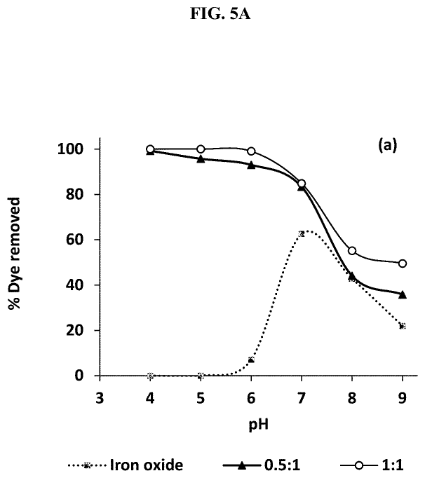

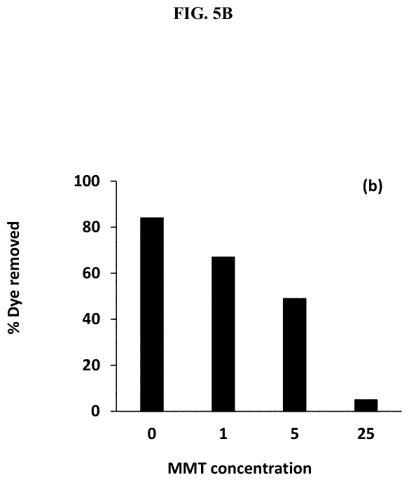

This example illustrates the effect of pH on the dye adsorption capacity of the inventive compositions. The diprotic dye, EBT, generally has pkₐ values of 6.2 and 11.5 (see e.g., El-Dars et al., 2015). FIG. 5A shows the influence of solution pH for the adsorption of the EBT by the synthesized adsorbents and FIG. 5B shows the effect of MMT buffer (explained below) concentration on the adsorption capacity of iron oxide. Adsorbents (0.5:1 and 1:1) showed a steady EBT removal within pH 4-7, followed by a reduction in the amount of EBT removed at pH 8 and 9. Within pH 4-6, the percentage removal was 93% to 100%. At low pH, the inventive adsorbents showed a surprisingly increased capacity for binding the EBT over iron oxide. This result was surprising because iron oxide did not remove the contaminant from pH 4-6 while the inventive composite exhibited extremely high percentage removal. In the case of the iron oxide adsorbent, EBT removal increased with increasing pH, with a maximum value being obtained at pH 7. The surface of the iron oxide contains hydroxyl groups that may undergo hydrogen bonding with —OH groups of the EBT. At higher pH, the negative charges on the adsorbent surface coupled with the negative charges on the EBT surface led to a decrease in the amount removed at higher pH values. Similar pH pattern for EBT removal using magnetic NiFe₂O₄ nanoparticle was observed by other authors (see e.g., Moeinpour et al., 2014).

Surprisingly, there was no EBT adsorption on the surface of the iron oxide at low pH values. Around this low solution pH range (4-5), the distribution of ≡Fe—OH₂⁺ (E indicates iron oxide backbone) hydroxyl groups on the surface of the iron oxide is approximately 100% (see e.g., Cornell & Schwertmann, 2003). Furthermore, the EBT dye is predominantly in its undissociated form, which is ˜99% and ˜94% at pH 4 and 5, respectively. To understand the chemistry behind this “pH effect” for iron oxide, surface complexation-ligand exchange mechanism was proposed as manifested in FIG. 5B. The effect of different concentrations of MMT buffer compared to water clearly show how the EBT removal efficiency decreases with increasing concentration of the buffer. The adsorption of anions (from the buffer) on iron oxide surface modify its charge properties and affect its ability to adsorb EBT. This surface complexation-ligand exchange mechanism dominates the adsorption at low solution pH as evidenced by the decrease in EBT removal efficiency from 83% (control) to 67% (1 mM MMT), 49% (5 mM MMT) and 5% (25 mM MMT). The results in FIG. 5B clearly demonstrate that even low concentrations (1 mM MMT) of anions can have a negative impact on adsorption of EBT on iron oxide surface. Other authors have also observed that that the presence of anions (phosphate) competes with natural organic matter and greatly reduces their adsorption on iron oxide surfaces (see e.g., Gu et al., 1995). It is worth noting that even extremely low concentrations of ions (<10⁻⁶M) were found to negatively reduce the adsorption of humic acid on goethite (α-FeOOH) (see e.g., Tipping, 1981). The control (water only), see FIG. 5B, depicts that, in the absence of foreign ions in solution, the major mechanism will be hydrogen bonding. Therefore, different adsorption mechanisms may operate when contaminants (e.g. EBT dye) are adsorbed on the surface of the iron oxide depending on the solution pH, the concentration of background ions in solution, the distribution of hydroxyl groups (example Fe—OH₂⁺ vs Fe—OH) and the relative amount of the dissociated and undissociated form of the contaminant in solution. Altogether, the 0.5:1 and 1:1 adsorbents demonstrated effective adsorption performance towards EBT compared to the bare iron oxide. This result was surprising because iron oxide did not remove the contaminant from pH 4-6 while the inventive composite exhibited extremely high percentage removal.

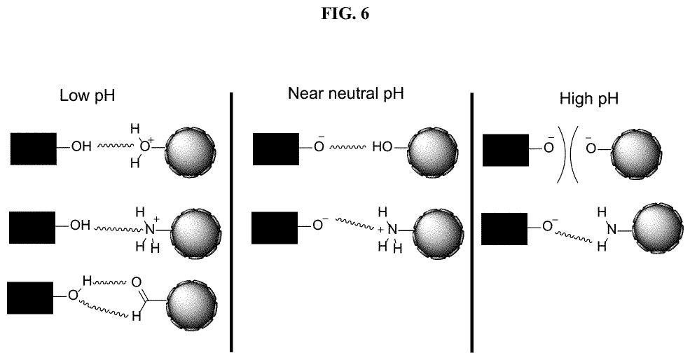

Not intending to be bound by theory, it is thought that at low pH, the main mechanism in operation is hydrogen bonding as shown in FIG. 6 (rectangular shape indicates the dye while the round shape represent the adsorbent). The abundance of several functional groups on 0.5 and 1:1 adsorbent like —OH₂⁺, —COOH, and —NH₃⁺ are able to more effectively hydrogen bond with the —OH group of EBT. At near neutral pH, both hydrogen bonding and electrostatic interaction is in effect (see FIG. 6). Here, not all the EBT dye has deprotonated and thus both the neutral and the dissociated form are still in solution. At pH 7, for example, about 86.4% of the dye is deprotonated compared to about 13.6% which is still in the neutral or undissociated form. The ammonium group on the surface of the adsorbent (0.5:1 and 1:1) can be electrostatically attracted to the negative charges on the dissociated EBT dye. At high pH, there is a lot of electrostatic repulsion between the EBT and the adsorbents (0.5:1 and 1:1) as a result of the increasing negative charges on their surfaces. This causes the percentage of EBT dye removed from solution to decrease to about 35% (0.5:1 adsorbent) and 49% (1:1 adsorbent) at pH 9.

### Example 8

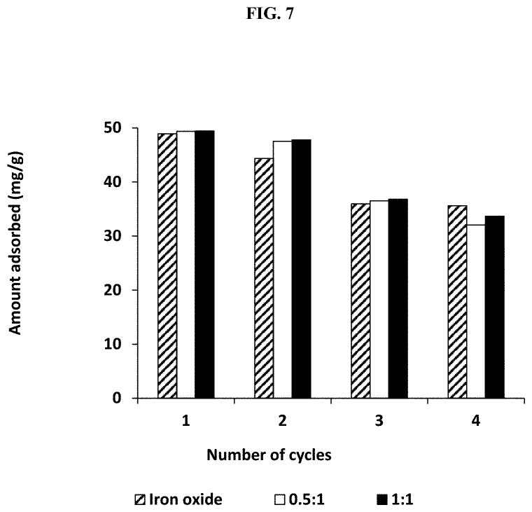

This example illustrates the capacity of the inventive adsorbent to desorb a dye and be prepared for reuse. The desorption and reusability of the prepared adsorbent was demonstrated following a recent protocol with slight modification (see e.g., Essandoh et al., 2015). Adsorbent loaded with dye was prepared by suspending 60 mg of the adsorbent in 30 mL of 50 mg/mL dye and rotating for 2 h at room temperature. The supernatant was analyzed by UV-vis spectrophotometry to determine the concentration of EBT dye left in the solution. The adsorbed dye was desorbed by triplicate washing with methanol (10 mL) and centrifuging at 4 k×g for 10 min. The adsorbent was then dried in an oven at 70° C. and reused for subsequent experiments using the same operational parameters. These adsorbents were further tested for their potential reuse. FIG. 7 shows that the adsorption capacity is nearly maintained after the first cycle. However, with subsequent reuses, the adsorption capacity was found to decrease. This is not unusual as multiple authors have also found a reduction in adsorption capacity when adsorbents are used multiple times (see e.g., Essandoh et al., 2015; Azharul Islam et al., 2018).

### Example 9

This example illustrates comparative data to conventional dye adsorbents. The adsorption capacities of the synthesized adsorbents were compared to other adsorbents that are reported in the literature for the removal of EBT (Table 6).

TABLE 6

| | Adsorption | |
|---|---|---|
| Adsorbent | capacity, mg/g | Reference number |
| Almond shell adsorbent | 6 | Şahin et al., 2013 |
| Cold plasma treated almond | 18 | Şahin et al., 2013 |
| shell | | |
| Microwave treated almond | 29 | Şahin et al., 2013 |
| shell | | |
| NiFe₂O₄ nanoparticles | 47 | Moeinpour et al., 2014 |
| Eucalyptus bark | 63 | Dave et al., 2011 |
| Rice hull-activated carbon | 160 | de Luna et al., 2013 |
| Scolymus hispanicus L. | 166 | Barka et al., 2011 |
| Hb/Fe₃O₄ composite | 178 | Essandoh & Garcia 2018 |
| Iron oxide | 123 | Current study |
| 0.5:1 | 204 | Current study |
| 1:1 | 217 | Current study |

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety, including any materials cited within such referenced materials. In addition to the citations above, the contents of the following references are also incorporated herein by reference in their entirety: US Patent Application Publication 2018/0222773. Furthermore, the invention encompasses any possible combination of some or all of the various embodiments and characteristics described herein and/or incorporated herein. In addition the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 30%, preferably by as much as 20%, and more preferably by as much as 10% to a reference quantity, level, value, or amount.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims. Although any methods and materials similar or equivalent to those described herein can be used in the practice or testing of the present invention, the preferred methods and materials are herein described. Those skilled in the art may recognize other equivalents to the specific embodiments described herein which equivalents are intended to be encompassed by the claims attached hereto.

The claimed invention is:

1. A composition comprising: an adsorbent having at least one type of protein, at least one type of peptide, and at least one type of iron oxide; wherein said adsorbent is capable of adsorbing at least one type of contaminant.

2. The composition of claim 1, wherein the at least one type of protein is hemoglobin selected from the group consisting of: mammalian hemoglobin, avian hemoglobin, fish hemoglobin, and combinations thereof.

3. The composition of claim 1, wherein the at least one type of peptide attaches to said protein from a reaction with an amino acid N-carboxyanhydride.

4. The composition of claim 3, wherein the amino acid N-carboxyanhydride is selected from the group consisting of: serine-N-carboxyanhydride, valine-N-carboxyanhydride, boc-gly-N-carboxyanhydride, and combinations thereof.

5. The composition of claim 1, wherein said iron oxide is selected from the group consisting of: iron (II) sulfate heptahydrate, iron (III) sulfate hydrate, and combinations thereof.

6. The composition of claim 1, wherein said iron oxide is selected from group consisting of: magnetite (Fe₃O₄), maghemite (γ-Fe₂O₃), and combinations thereof.

7. The composition of claim 1, wherein said iron oxide comprises an iron (III) to an iron (II) ratio from about 1.5:1 to about 2.5:1.

8. The composition of claim 1, wherein a ratio of concentration of said protein to said peptide in the adsorbent is from about 20:1 to about 2:1.

9. The composition of claim 1, wherein a mass ratio of said protein to said iron oxide in the adsorbent is from about 0.0625:1 to about 2:1.

10. The composition of claim 1, wherein the adsorbent has an adsorption capacity of up to about 200 milligrams said contaminant per gram of the adsorbent.

11. The composition of claim 1, wherein said contaminant is selected from the group consisting of: inorganic dyes, organic dyes, pesticides, and combinations thereof.

12. The composition of claim 1, wherein said contaminant is selected from the group consisting of: azo dyes, diazo dyes, arylmethanes, xanthenes, indole dyes, organophosphorus, triazine, atrazine, glyphosate, 2,4-dichlorophenoyxacetic acid, naphthalene, pentachlorophenol, chloropyrifos, catechol, trichloroethylene, organochlorine compounds, zinc, chromium, copper, heavy metals, arsenic, and combinations thereof.

13. The composition of claim 1, wherein the adsorbent comprises a solid form.

14. The composition of claim 13, wherein the solid form comprises a substantially pure solid form.

15. The composition of claim 13, wherein the solid form comprises a powder, granule, or tablet.

16. The composition of claim 1, wherein the adsorbent comprises liquid, semi-solid, or gel.

17. A method of removing at least one type of contaminant from water, said method comprising contacting said water with an effective amount of the composition of claim 1.

18. The method of claim 17, wherein said water is wastewater.

19. The method of claim 17, wherein the effective amount comprises from about 0.003 grams to about 0.06 grams adsorbent per milligram of said contaminant in said water.

20. The method of claim 17, wherein said contaminant is selected from the group consisting of: inorganic dyes, organic dyes, pesticides, and combinations thereof.

21. The method of claim 17, wherein said contaminant is selected from the group consisting of: azo dyes, diazo dyes, arylmethanes, xanthenes, indole dyes, organophosphorus, triazine, atrazine, glyphosate, 2,4-dichlorophenoyxacetic acid, naphthalene, pentachlorophenol, chloropyrifos, catechol, trichloroethylene, organochlorine compounds, zinc, chromium, copper, heavy metals, arsenic, and combinations thereof.
